(19) United States
(12) Patent Application Publication
(10) Pub. No.: US 2015/0369926 A1
(43) Pub. Date: Dec. 24, 2015

(54) RADIOGRAPHIC PHOTOGRAPHING APPARATUS AND RADIOGRAPHIC PHOTOGRAPHING SYSTEM

(71) Applicant: CANON KABUSHIKI KAISHA, Tokyo (JP)

(72) Inventors: Tomoaki Ichimura, Kitamoto-shi (JP); Taiki Takei, Yokohama-shi (JP)

(21) Appl. No.: 14/738,671

(22) Filed: Jun. 12, 2015

(30) Foreign Application Priority Data
Jun. 18, 2014 (JP) 2014-125730

(51) Int. Cl. G01T 1/17; G01N 23/04

(52) U.S. Cl. CPC G01T 1/17; G01N 23/04

(57) ABSTRACT

A radiographic photographing apparatus includes a radiation sensor panel including a photoelectric conversion unit in which a conversion element configured to detect radiation or light is arranged; a light source unit having a light source configured to emit light having a wavelength different from the radiation to the radiation sensor panel; and a conductive member arranged between the radiation sensor panel and the light source unit and configured to receive a supply of a fixed potential.

### BACKGROUND OF THE INVENTION

1. Field of the Invention

This disclosure relates to a radiographic photographing apparatus and a radiographic photographing system.

2. Description of the Related Art

A radiographic photographing apparatus having a digital sensor panel including a plurality of conversion elements capable of detecting radiation is known. In a conventional radiographic photographing apparatus, when photographing is performed by a plurality of times, an electric charge generated and accumulated by the conversion elements by irradiation of radiation at the time of previous photographing appears on a subsequent photographed image as an after image artifact. As a countermeasure for suppressing generation of such an after image, there is a known technology in which a light source configured to emit light having a wavelength different from the radiation is arranged in the radiographic photographing apparatus, and the conversion elements are irradiated with light from the light source. Specifically, the radiation sensor panel is irradiated with light from the light source, so that fluctuation of characteristics among the plurality of conversion elements caused by an electric charge accumulated at the time of photographing is prevented or at least minimized. In addition, there is a known technology that the light source is provided with a light-emitting source at an end portion thereof, and the radiation sensor panel is caused to be irradiated efficiently with light from the light source via a light guide plate, a diffusing plate, and a reflecting plate.

Japanese Patent application Laid-Open No. 2014-71077 discloses a radiographic photographing apparatus including a radiation sensor panel having a photoelectric conversion element which constitutes part of a conversion element and a light source unit configured to emit light having a wavelength different from radiation to the radiation sensor panel. In addition, Japanese Patent application Laid-Open No. 2014-71077 discloses a configuration in which the light source unit is fixed from side surfaces so as to sit or straddle on the radiation sensor panel, so that portions of a light guide plate, a diffusing plate, and a reflecting plate, where light emitted by the light source unit is transmitted, are not adhered to the radiation sensor panel.

However, the configuration of the light source unit disclosed in Japanese Patent Laid-Open No. 2014-71077 may potentially generate static electricity among the portions of the light source unit due to vibration or impacts exerted on the radiographic photographing apparatus. In particular, either contact, separation, and friction between the radiation sensor panel and the light source may occur due to vibrations, which may result in charging caused by static electricity. The portions of the light source unit described above may generate static electricity in areas not fixed by a bonding adhesive due to friction or the like. Consequently, the generated static electricity could propagate to the radiation sensor panel, and cause deterioration of characteristics of the conversion elements. Therefore, quality of the photographed image may be negatively affected.

### SUMMARY OF THE INVENTION

In consideration of the above-described shortcomings of conventional technology, this disclosure provides a radiographic photographing apparatus having a light source configured to emit light having a wavelength different from radiation to a conversion element and a radiation sensor panel, in which an influence of static electricity on quality of a photographed image is suppressed.

According to an aspect of the present applicant, a radiographic photographing apparatus includes a radiation sensor panel including a photoelectric conversion unit in which conversion elements configured to detect radiation or light are arranged; and a light source unit having a light source configured to emit light having a wavelength different from the radiation to the photoelectric conversion unit, wherein a conductive member is arranged between the radiation sensor panel and the light source unit and a fixed potential is supplied to the conductive member.

Further features of the present invention will become apparent from the following description of exemplary embodiments with reference to the attached drawings.

### BRIEF DESCRIPTION OF THE DRAWINGS

FIGS. 1A and 1B are respectively a plan view and a cross-sectional view of a radiographic photographing apparatus according to a first embodiment.

FIGS. 2A and 2B are cross-sectional views of the radiographic photographing apparatus according to a second embodiment.

FIGS. 3A and 3B are respectively a plan view and a cross-sectional view of a conductive member of the second embodiment.

FIG. 4 is a cross-sectional view of the radiographic photographing apparatus according to a third embodiment.

FIG. 5A is a cross-sectional view of the radiographic photographing apparatus according to a fourth embodiment.

FIG. 5B is a plan view of the conductive member of the fourth embodiment.

FIG. 6 is a schematic view of a radiographic photographing system according to a fifth embodiment.

### DESCRIPTION OF THE EMBODIMENTS

### First Embodiment

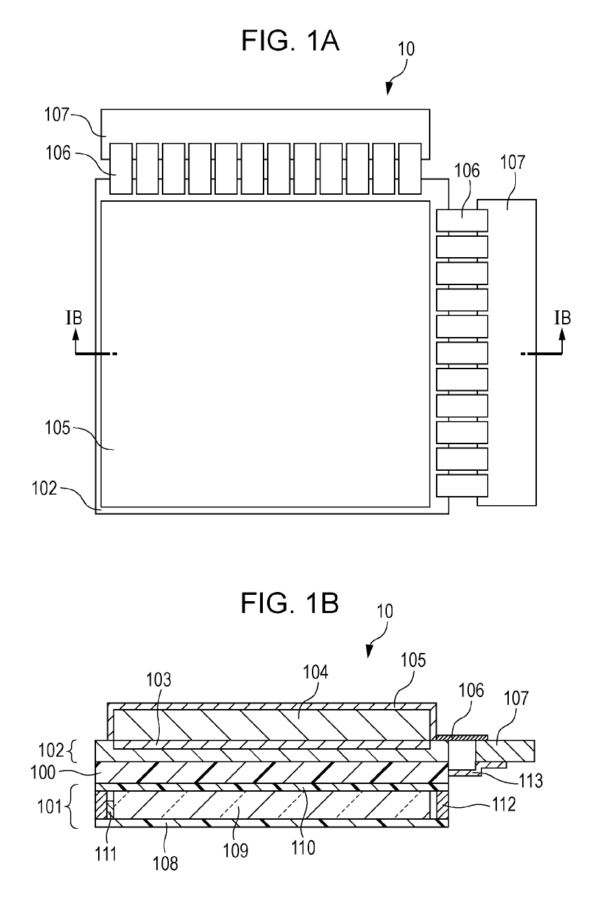

Referring now to FIGS. 1A and 1B, a radiographic photographing apparatus of the first embodiment will be described. FIG. 1A is a plan view viewed from a radiation incident surface side, and FIG. 1B is a cross-sectional view taken along a line IB-IB in FIG. 1A.

A radiographic photographing apparatus 10 includes at least a conductive member 100, a light source unit 101, and a radiation sensor panel 102. The conductive member 100 is arranged between the radiation sensor panel 102 and the light source unit 101 and a fixed potential is supplied to the conductive member 100. The reason will be described in detail below.

The radiation sensor panel 102 has a function that converts radiation into an image signal. In X-ray imaging, the radiation sensor panel 102 converts X-ray radiation into an X-ray image signal. The radiation sensor panel 102 includes a photoelectric conversion unit 103 as an area in which a plurality of photoelectric conversion elements (pixels) are arranged on a non-illustrated base substrate. The substrate is formed, for example, of glass or silicone. The radiation sensor panel 102 is provided with a fluorescent member 104 (configured to convert radiation into visible light arranged on a detecting surface, which corresponds to a surface having the photoelectric conversion unit 103. The fluorescent member 104 emits light by radiation irradiated by the radiographic photographing apparatus 10, and the plurality of photoelectric conversion elements of the radiation sensor panel 102 convert the emitted light into an image signal. The fluorescent member 104 includes a fluorescent member protecting layer 105 formed of a metal or a resin arranged on an upper surface thereof. The fluorescent member protecting layer 105 may improve durability of the fluorescent member 104. An example of the fluorescent member 104 is a scintillator that coverts radiation to visible light which is then converted into an electric charge by the photoelectric conversion unit 103. The radiation sensor panel 102 may employ conversion elements configured to convert the radiation directly into an electric charge instead of the fluorescent member 104 and the photoelectric conversion unit 103.

A circuit substrate 107 has a function that controls the radiation sensor panel 102. The circuit substrate 107 is electrically connected to the radiation sensor panel 102 via, for example, a flexible wiring substrate 106. The flexible wiring substrate 106 and the circuit substrate 107 are provided with various integrated circuit (IC) units. The integrated circuit includes a drive circuit configured to drive the photoelectric conversion unit 103 and a reading circuit configured to read out an electric signal. In addition, the integrated circuit includes a control circuit configured to control at least one of the drive circuit and the reading circuit. The circuit substrate 107 further includes a control circuit configured to control a light source 111 described later. The control circuit configured to control the light source 111 may be formed on a circuit substrate, which is different from the circuit substrate 107.

The light source unit 101 emits light having a wavelength different from the radiation. Therefore, the light source unit 101 has a function that emits light for improving characteristics of the radiation sensor panel 102. The light source unit 101 is arranged on the radiation sensor panel 102 on a side opposite to the detecting surface thereof. The light source unit 101 is arranged without direct contact with the radiation sensor panel 102.

The light source unit 101 has a layered structure including a reflecting plate 108, a light guide plate 109, a diffusing plate 110, and the light source 111. The light source 111 is fixed to the reflecting plate 108. The light source 111 is not limited thereto, and may be fixed to the light guide plate 109. A spacer 112 is arranged between the reflecting plate 108 and the diffusing plate 110. The spacer 112 fixes positions of the diffusing plate 110 and the reflecting plate 108 at a predetermined distance on the outside of the light source 111. The light guide plate 109 is positioned in an interposed manner in a space provided by the spacer 112. No adhesive agent is arranged in areas between the reflecting plate 108, the light guide plate 109 and the diffusing plate 110, where light emitted by the light source 111 may be transmitted, so that these plates are not fixed with the adhesive agent. In this configuration, unevenness of transmission intensity of light due to unevenness of the adhesive agent in the area in which light may be transmitted is suppressed.

Configurations of the light source unit 101 will be described, respectively. The reflecting plate 108 has a function that reflects light transmitted to the reflecting plate 108 toward the light guide plate 109, and enhancing light amount incident on the radiation sensor panel 102. The material of the reflecting plate 108 used here is, for example, a member containing PET. The light guide plate 109 has a function that guides light emitted by the light source 111 uniformly to the diffusing plate 110. The material of the light guide plate 109 used here is a resin material having high light propagation efficiency and high transparency, for example, an acrylic resin. The diffusing plate 110 has a function that diffuses light emitted by the light source 111 and propagating in the light guide plate 109 in a plane direction of the diffusing plate 110 to direct the light toward the radiation sensor panel 102. In other words, the diffusing plate 110 in the light source unit 101 has a function as a light-emitting surface which emits light. The diffusing plate 110 used here is, for example, a member containing PET. The light source 111 has a function that emits light for improving the characteristics of the radiation sensor panel 102. Examples of a wavelength range of the light having wavelengths different from the radiation include infrared light or visible light. The light source 111 used here includes, for example, LED or laser.

The conductive member 100 is arranged between the radiation sensor panel 102 and the light source unit 101 and a fixed potential is supplied to the conductive member 100. Since the fixed potential is supplied, the conductive member 100 acts to release static electricity which may be generated in the light source unit 101 to a destination of the fixed potential. In the first embodiment, the conductive member 100 is fixed between the radiation sensor panel 102 and the light source unit 101 with the conductive member 100 interposed therebetween. Therefore, adhesiveness between the light source unit 101 and the conductive member 100 is improved, so that the static electricity generated in the light source unit 101 may be released efficiently to the destination of the fixed potential. The conductive member 100 is electrically connected to the circuit substrate 107 via a substrate connecting unit 113, and the fixed potential is supplied from the circuit substrate 107. The fixed potential to be supplied may be a ground potential used in the circuit substrate 107, for example. Alternatively, various fixed potentials such as a voltage potential supplied to the photoelectric conversion unit 103 and a voltage potential supplied to the reading circuit may be used. In the case where the ground potential is supplied, the conductive member 100 may be electrically connected to an external housing (not illustrated) in which the radiation sensor panel 102 is contained.

The conductive member 100 is larger at least than an area in which the photoelectric conversion unit 103 of the radiation sensor panel 102 is provided, and is arranged so as to cover the photoelectric conversion unit 103. In this configuration, an influence of the static electricity at least on the photoelectric conversion unit 103 is suppressed. Subsequently, a material which may be used in the conductive member 100 will be described. The conductive member 100 can have a sheet resistance of 10 kΩ or lower for securing a predetermined conductive property. The conductive member 100 is configured to transmit light emitted by the light source unit 101 therethrough to improve the characteristics of the conversion elements in predetermined time, and hence can have a transmittance of 50% or higher for infrared light or visible light emitted by the light source 111. The conductive member 100 is arranged between a surface of the radiation sensor panel 102 opposite to the detecting surface and the light source unit 101. In this case, a configuration in which the radiation for acquiring the image signal transmits through the light source unit 101 and through the conductive member 100 may be achieved. When detecting the radiation with this configuration, the conductive member 100 can have a radiation transmittance of 90% or higher. With the conductive member 100 securing the radiation transmittance of 90% or higher, attenuation of the image signal may be suppressed effectively.

Examples of the material that may be used for the conductive member 100 include a resin film such as a polyethylene terephthalate (PET) plate provided with an inorganic conductive film or an organic conductive film formed thereon. Examples of the material that may be used for the inorganic conductive film include SnO2, ZnO and ITO. Examples of the material of the organic conductive film include polypyrrole. Examples of a method of forming the organic or inorganic conductive film include a CDV method, a vacuum deposition method, and a screen printing. Examples of the material of the conductive member 100 also include a material containing a transparent resin having conductive property. In addition, a transparent conductive film such as indium-tin oxide (ITO) may be used as the conductive member 100. Furthermore, the conductive member 100 may include a mesh portion formed of metallic wires arranged in a net pattern (mesh pattern). The width of metallic wires can be thinner than the size of the photoelectric conversion element viewed from the radiation incident surface side. Specifically, the width of the wires not larger than 30% of the size of the photoelectric conversion element achieves a mesh having an opening rate of 50% or higher. The conductive member 100 formed of one of these members is capable of suppressing an increase in the weight of the radiographic photographing apparatus and suppressing the static electricity from propagating to the radiation sensor panel.

According to the first embodiment, even though static electricity is generated by the light source unit, fluctuation of the potential may be suppressed by the conductive member because the fixed potential is supplied thereto. Therefore, with the radiographic photographing apparatus having the light source configured to emit light having a wavelength different from radiation to a conversion element and the radiation sensor panel, a negative influence on the quality of a photographed image can be actively suppressed.

### Second Embodiment

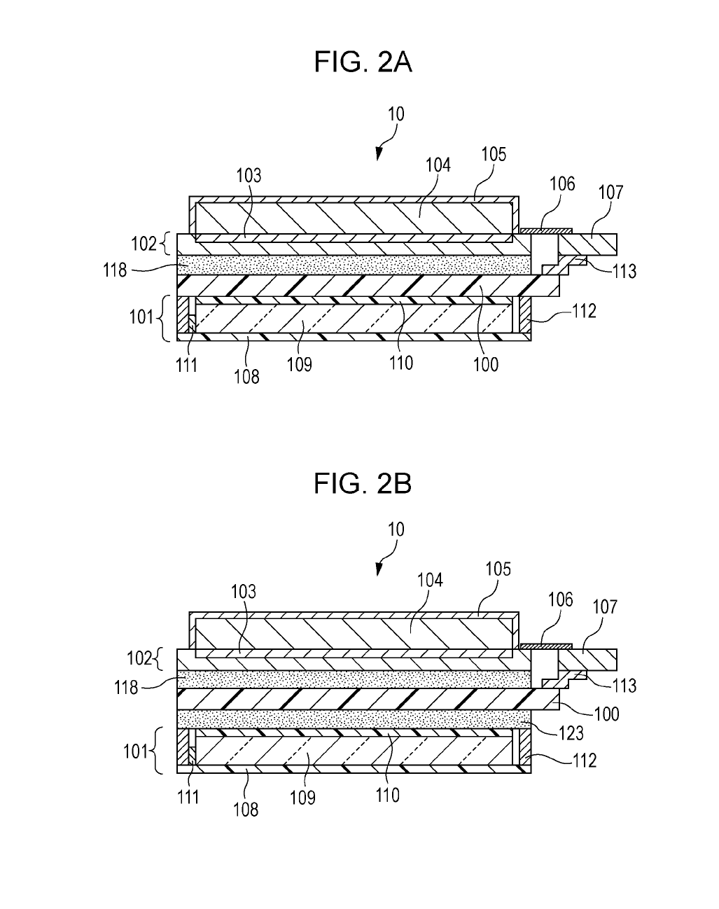

Referring now to FIGS. 2A and 2B, the radiographic photographing apparatus of a second embodiment will be described. The second embodiment is different from the first embodiment in that the radiation sensor panel and the light source unit are adhered with an adhesive layer interposed therebetween. The second embodiment is also different from the first embodiment in that the conductive member has a function that diffuses light. FIG. 2A is a cross-sectional view of the radiographic photographing apparatus 10. The plan view is the same as FIG. 1A.

The radiation sensor panel 102 and the light source unit 101 are adhered with an adhesive layer 118 interposed therebetween. In this case, the adhesive layer 118 transmits light emitted by the light source unit 101, and hence a material having a high transmittance for visible light (can be 90% or higher) can be employed. Examples of the material of the adhesive layer 118 include acrylic-based, epoxy-based, and silicone-based adhesive agents. As illustrated in FIG. 2B, the light source unit 101 and the conductive member 100 may be adhered to each other with a second adhesive layer 123 interposed therebetween. Therefore, the second adhesive layer 123 may have a function that diffuses light emitted by the light source unit 101. Examples of material of the second adhesive layer 123 can include a milky white silicon resin.

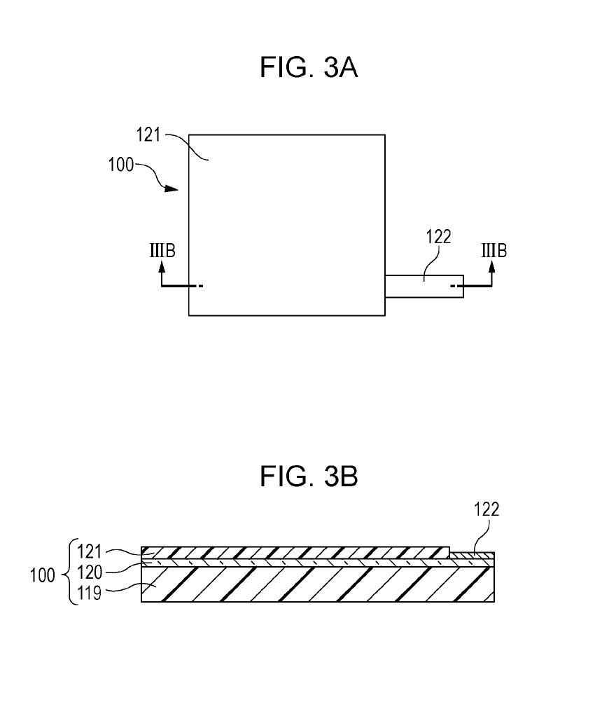

FIG. 3A is a drawing of the conductive member 100 viewed from the radiation incident surface side. FIG. 3B is a cross-sectional view taken along a line IIIB-IIIB of FIG. 3A. The conductive member 100 has a function that receives a supply of the fixed potential and diffusing light emitted by the light source unit 101. The conductive member 100 includes a conductive layer 120 and a diffusing layer 121 layered on a base plate 119 in this order. The base plate 119 is used for depositing the conductive layer 120, and, for example, a sheet-formed PET may be used. The conductive layer 120 is a layer having a conductive property and a light transmitting property and, for example, a transparent conductive film such as ITO may be used. The diffusing layer 121 has a function that diffuses light. An acrylic resin containing SiO2 fine particles mixed therein may be used for the diffusing layer 121. In addition, as illustrated in FIG. 3B, the conductive member 100 includes a conductive film 122 layered on a portion thereof, which is not in contact with the photoelectric conversion unit 103. The conductive film 122 is layered for improving the conductive property of the conductive member 100. The conductive film 122 is formed for example by depositing copper.

According to the second embodiment, the positions of the light source unit 101 and the radiation sensor panel 102 are fixed by the adhesive layer 118. Accordingly, adhesiveness of the light source unit 101 and the conductive member 100 is improved. Therefore, propagation of the static electricity to the radiation sensor panel may efficiently be suppressed even though the radiographic photographing apparatus receives an impact.

### Third Embodiment

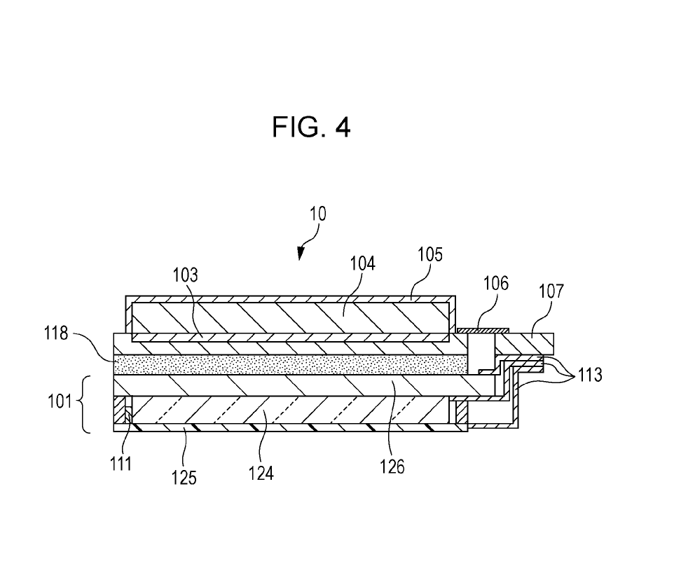

Referring now to FIG. 4, the radiographic photographing apparatus of a third embodiment will be described.

In the radiographic photographing apparatus 10 of the third embodiment, the substrate connecting units 113 are connected to a light guide plate 124, a reflecting plate 125, and a diffusing plate 126 of the light source unit 101, respectively, for supplying a fixed potential thereto. The plates each include a member having a conductive property for securing the conductive property and supplying the fixed potential via the substrate connecting unit 113. For example, a PET sheet provided with a metallic conductive layer formed thereon can be used as the reflecting plate 125. Examples of the metal include aluminum. For example, a PET sheet provided with ITO arranged thereon as a conductive layer can be used as the light guide plate 124. For example, a PET sheet provided with ITO arranged thereon as a conductive layer can be used as the diffusing plate 126. The fixed potential is supplied to the portions of the light source unit 101, so that the static electricity generated from the portions of the light source unit 101 can be suppressed from propagating to the radiation sensor panel 102. Each of the substrate connecting units 113 connected to the plates may be connected electrically. In this case, the substrate connecting units 113 may act to make a potential difference between the plates which constitute part of the light source unit 101 constant to improve the effect of removing the static electricity.

According to the third embodiment, since the fixed potential is supplied to at least one of the light guide plate, the reflecting plate, and the diffusing plate which constitute part of the light source unit, fluctuations of the potentials of the plates which constitute part of the light source unit may be suppressed. Therefore, propagation of the static electricity to the radiation sensor panel may be suppressed, and the influence on the quality of the photographed image may be suppressed.

### Fourth Embodiment

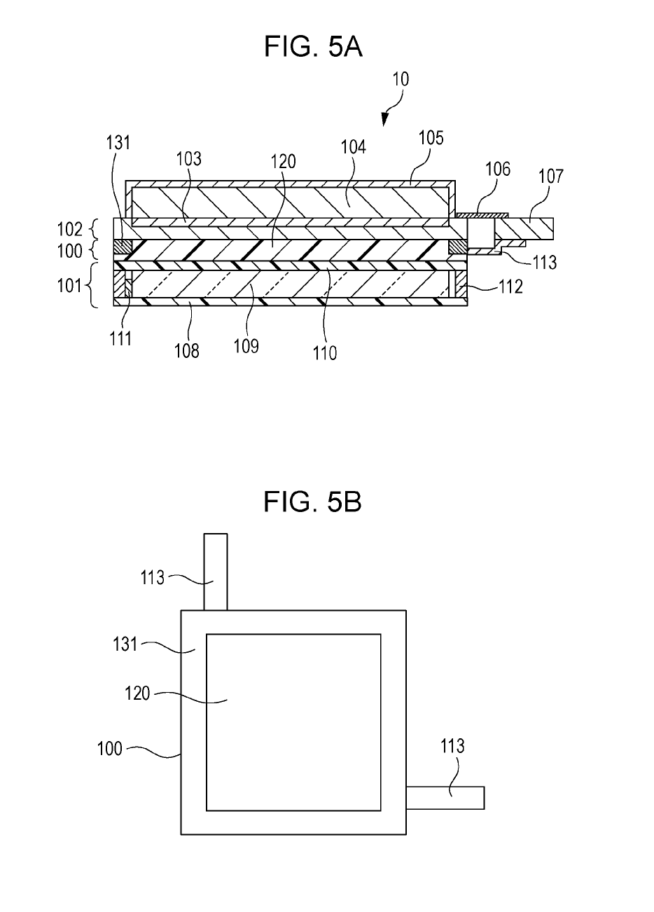

Referring now to FIGS. 5A and 5B, the radiographic photographing apparatus of a fourth embodiment will be described. The fourth embodiment is different from other embodiments in that an area of the conductive member different from an area opposing the photoelectric conversion units has a conductive property higher than the area opposing the photoelectric conversion units.

FIG. 5A illustrates the radiographic photographing apparatus 10 including the conductive member 100 arranged thereon. FIG. 5B is a drawing of the conductive member 100 viewed from the radiation incident surface side. The conductive member 100 includes the conductive layer 120 and a high conductive layer 131. The conductive member 100 receives a supply of the fixed potential via the substrate connecting unit 113. The conductive layer 120 is provided in an area opposing the photoelectric conversion unit 103. The conductive layer 120 is formed, for example, of a transparent conductive film (ITO or the like) for making the light emitted by the light source unit 101 transmit therethrough. The conductive layer 120 is capable of suppressing attenuation of the light emitted by the light source unit 101 by using the transparent conductive film. The high conductive layer 131 is provided in the area different from an area opposing the photoelectric conversion unit 103. The high conductive layer 131 does not need to transmit visible light, and has a conductive property higher than that of the conductive layer 120. Therefore, the conductive member 100 is capable of suppressing the propagation of the static electricity by the high conductive layer 131 being formed thereon. The high conductive layer 131 formed on the conductive member 100 by depositing aluminum is used. With the configuration described above, the conductive property of the conductive member is enhanced, propagation of static electricity to the radiation sensor panel is suppressed, and an influence on the quality of the photographed image may be suppressed in the radiographic photographing apparatus.

### Fifth Embodiment

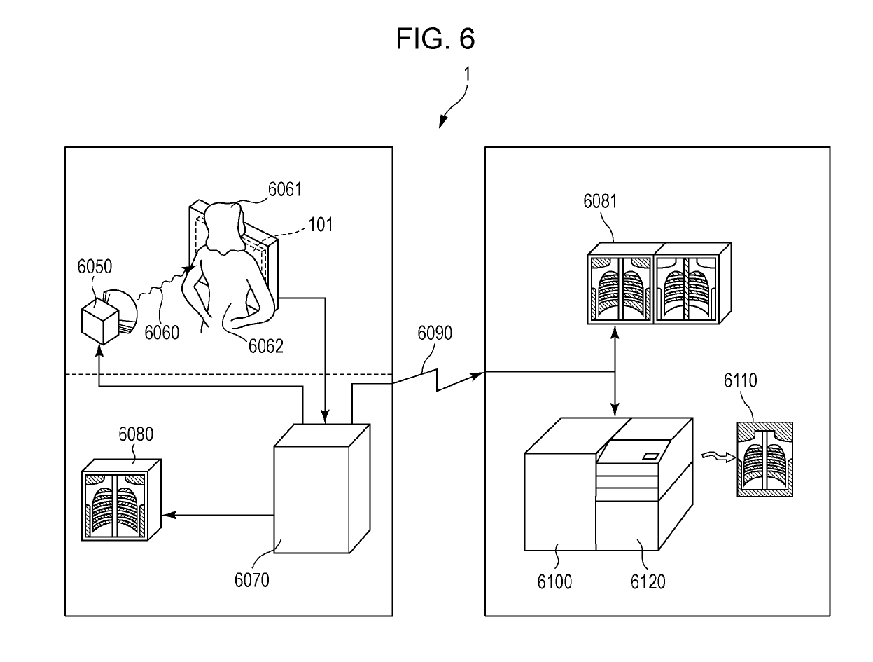

FIG. 6 illustrates a configuration of a radiographic photographing system in which the radiographic photographing apparatus of the first to fourth embodiments is used.

A radiographic photographing system 1 includes an X-ray tube 6050 as a radiation source, the radiographic photographing apparatus 101, an image processor 6070 as a signal processing device, and displays 6080 and 6081 as display devices. In addition, the radiographic photographing system 1 includes a film processor 6100 and a laser printer 6120.

A radiation (X-ray) 6060 generated by the X-ray tube 6050 as the radiation source is transmitted through a photographing portion 6062 of a subject to be examined 6061, and enters the radiographic photographing apparatus 101. The radiation entered the radiographic photographing apparatus 101 includes information on an interior of the photographing portion 6062 of the subject to be examined 6061.

With the radiation entering the radiographic photographing apparatus 101, electrical information on the photographing portion 6062 of the subject to be examined 6061 is obtained. This information is converted into a digital format, and is output to the image processor 6070 as the signal processing device.

A computer provided with a CPU, an RAM, and an ROM is applied to the image processor 6070 as the signal processing device. In addition, the image processor 6070 has a recording medium in which various items of information can be recorded as a recording device. For example, the image processor 6070 includes an HDD, an SSD, and a recordable optical disk drive as the recording devices integrated therein. Alternatively, the image processor 6070 may be configured to allow the HDD, the SSD, and the recordable optical disk drive as the recording devices to be connected to the outside.

The image processor 6070 as the signal processing device performs predetermined signal processing on the information and make the display 6080 as the display device display the result. Accordingly, the subject to be examined or an examiner may observe the image. Also, the image processor 6070 is capable of recording the information in the HDD, the SSD, and the recordable optical disk drive as recording devices.

The image processor 6070 may have a configuration having an interface which is capable of transmitting the information to the outside as an information transmitting device. For example, an interface to which an LAN or a telephone line 6090 can be connected is applicable as the interface as the transmitting device as described above.

The image processor 6070 is capable of transmitting the information to a remote site via the interface as the transmitting device. For example, the image processor 6070 transmits the information to a doctor room located apart from an X-ray room in which the radiographic photographing apparatus 101 is installed. Accordingly, a doctor and the like is allowed to examine the subject to be examined at the remote site. The radiographic photographing system 1 is also capable of recording the information on a film 6110 by the film processor 6100 as the recording device.

### Advantageous Effects of Invention

According to this disclosure, with the radiographic photographing apparatus having the light source configured to emit light having a wavelength different from radiation to the conversion element and the radiation sensor panel, and a conductive member arranged between the radiation sensor panel and the light source unit and a fixed potential being supplied to the conductive member, an influence on the quality of a photographed image caused by static electricity may be effectively suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-125730, filed Jun. 18, 2014, which is hereby incorporated by reference herein in its entirety.

What is claimed is:

1. A radiographic photographing apparatus comprising:
a radiation sensor panel including a photoelectric conversion unit in which a conversion element configured to detect radiation or light is arranged; and
a light source unit having a light source configured to emit light having a wavelength different from the radiation to the photoelectric conversion unit, wherein
a conductive member is arranged between the radiation sensor panel and the light source unit and a fixed potential is supplied to the conductive member.

2. The radiographic photographing apparatus according to claim 1, wherein
the light source unit further includes a light guide plate, a diffusing plate, and a reflecting plate, and
an adhesive agent is not arranged between the light guide plate, the diffusing plate, and the diffusing plate in areas thereof where light emitted by the light source is transmitted.

3. The radiographic photographing apparatus according to claim 1, wherein
the light having a wavelength different from the radiation emitted by the light source unit includes visible light, and
the conductive member has a transmittance of at least 50% for transmitting the visible light therethrough.

4. The radiographic photographing apparatus according to claim 1, wherein
the radiation sensor panel includes a detecting surface on which a plurality of the conversion elements are provided, and
the conductive member is arranged between a surface opposite to the detecting surface and the light source unit.

5. The radiographic photographing apparatus according to claim 4, wherein the conductive member has a transmittance of at least 90% for transmitting the radiation therethrough.

6. The radiographic photographing apparatus according to claim 1, wherein the conductive member is electrically connected to a circuit substrate configured to control the radiation sensor panel, and receives a supply of the fixed potential from the circuit substrate.

7. The radiographic photographing apparatus according to claim 1, wherein the fixed potential is a ground potential or a voltage potential.

8. The radiographic photographing apparatus according to claim 1, wherein the radiation sensor panel and the light source unit are fixed with the conductive member interposed therebetween.

9. The radiographic photographing apparatus according to claim 1, wherein the radiation sensor panel and the light source unit are fixed with an adhesive layer including an adhesive agent interposed therebetween.

10. The radiographic photographing apparatus according to claim 9, wherein
the light having a wavelength different from the radiation emitted by the light source unit includes visible light, and
the adhesive layer has a transmittance of at least 90% for transmitting the visible light therethrough.

11. The radiographic photographing apparatus according to claim 1, wherein the conductive member has an area of the radiation sensor panel different from an area opposing the area in which the plurality of conversion elements are provided with a conductive property higher than that of the area opposing the area in which the plurality of conversion elements are provided.

12. A radiographic photographing apparatus comprising:
a radiation sensor panel configured to convert radiation into an image signal; and
a light source unit having a light source configured to emit light having a wavelength different from the radiation, a light guide plate, a diffusing plate, and a reflecting plate, wherein
the light source unit includes a conductive member having a conductive property, the conductive member arranged in at least one of the light guide plate, the reflecting plate, and the diffusing plate, and light source unit receives a supply of a fixed potential via the conductive member.

13. The radiographic photographing apparatus according to claim 1, wherein the conductive member is provided with a conductive film arranged thereon, wherein the conductive film includes a PET (polyethylene terephthalate) plate having a conductive property.

14. The radiographic photographing apparatus according to claim 1, wherein the conductive member includes a mesh portion having metallic wires arranged in a mesh pattern.

15. A radiographic photographing system comprising:
the radiographic photographing apparatus according to claim 1; and
a signal processing device configured to process a signal from the radiographic photographing apparatus.
